(19) United States
(12) Patent Application Publication
(10) Pub. No.: US 2018/0098661 A1
(43) Pub. Date: Apr. 12, 2018

(54) HOT SWAPPABLE GRILL SMOKER ELEMENT CONTAINER

(71) Applicants: DAVE DODDS, SANTA ROSA, CA (US); DEL WOLVERTON, SANTA ROSA, CA (US); DEREK WAYNE BAILEY, PHILADELPHIA, PA (US)

(72) Inventors: DAVE DODDS, SANTA ROSA, CA (US); DEL WOLVERTON, SANTA ROSA, CA (US); DEREK WAYNE BAILEY, PHILADELPHIA, PA (US)

(73) Assignee: WOLVERTONBAILEY INNOVATIONS, INC., SANTA ROSA, CA (US)

(21) Appl. No.: 15/612,089

(22) Filed: Jun. 2, 2017

Related U.S. Application Data
(60) Provisional application No. 62/345,214, filed on Jun. 3, 2016.

(51) Int. Cl. A47J 37/07; A23B 4/052

(52) U.S. Cl. CPC A47J 37/0786; A23B 4/0523

(57) ABSTRACT

A hot swappable grill smoker element container assembly which allows for the changing of various wood elements without opening the smoker lid or allowing heat to escape. The ability to hot swap wood elements provides a method for chefs to create new and unique flavors in meats without the negative effects on the smoking process of opening the lid of the grill or smoker.

### CROSS-REFERENCE TO RELATED APPLICATIONS

The present application claims the benefit of priority of U.S. Provisional Patent Application No. 62/345,214, filed Jun. 3, 2016

### BACKGROUND

### Field of Invention

This invention relates to a container which attaches to a barbecue grill smoker and holds grill smoker elements such as wood or wood pellets, and which will work with charcoal, gas and electric grill smokers. Specifically, the element container attaches to a grill, holds various types of wood elements, and allows the wood elements to be changed without lifting the lid of the grill or smoker.

### Background

Traditional BBQ cooking is smoking. The real deal is meat that is cooked at low temperatures, over live coals, with hardwood added to create that delicious smoky taste. Hardwood smoke gives BBQ extra flavor. Different woods impart different flavors. Hickory, mesquite, and oak wood each impart a bold flavor for meats like beef and pork. Apple, cherry and other fruit woods are milder and are ideal for pork or chicken.

As grill & smoke chefs become more creative in crafting new and unique flavors in their meats, the need to change the wood type during the smoking process is desired.

Perhaps the most difficult part of smoking is not lifting the lid. Every time one peeks under the lid of removes the lid to add or remove a wood element, valuable heat and smoke is allowed to escape. In fact, keeping the lid on the smoker to avoid wild temperature swings or burning out your coals or wood to quickly may be the most important factor in getting perfect results from smoking meats.

### DISCLOSURE OF PRESENT INVENTION

Changing the wood elements without removing the grill or smoker lid during the smoking and cooking process, is imperative so that the cooking temperature does not fluctuate widely due to the fuel elements such as wood or charcoal not remaining at stable levels.

Accordingly, the present invention has been made in order to solve the above-mentioned problems, and it is an object of the present invention to provide a means quickly and easily change out smoking elements such as woods and add new elements without opening the smoker lid or drastically reduce heat due to the slow removal of old wood elements with new elements by providing a container that holds the wood elements that can be swapped for another container holding another wood element, i.e. allowing the changing from hickory to mesquite. The present invention is in effect a hot swappable device and apparatus, allowing the changing of wood elements without interrupting the cooking process.

Another object of the present invention is to provide a device and method of mixing the smoking elements during the smoking process to create new and unique flavors in the meats which are being smoked. A chef might decide to smoke with hickory for one hour, mesquite for two hours, and oak for two hours, as an example, to create a new flavor in the smoked meat. These new flavors could have considerable commercial value to say a food chain seeking to offer a flavor of meat not available from a competitor.

Another object of the present invention is to provide a method of feeding wood elements into the burn chamber without letting out heat. Ribs, brisket, and pulled pork take hours to smoke properly, so adding more coals or wood elements will typically be necessary. The present invention incorporates a sliding door, handle and lever which allows the adding coals or wood elements quickly to keep temperatures inside the smoker between 225 and 250 degrees. The already lit elements inside the smoker will start the newly added elements gradually, maintaining the temperature.

Still further objects and advantages of the container handle and trap door opener mechanism will become apparent from a consideration of the ensuing description and drawings.

### SUMMARY

According to the present invention, several improvements were made to the traditional barbecue grill smoker. The first improvement comprises a swappable container assembly which holds various types of wood smoker elements i.e. (wood chips, or wood pellets). The handle of the container can be used to easily pull out the container and insert a new container to change wood elements. The ability to open and close the bottom feeder door reduces the spilling of pellet chips during a container swap.

The second improvement comprises the container handle which also operates a sliding or trap door apparatus located at the bottom of the container which opens to feed the wood elements into a fuel supply auger at the bottom of a grill. Currently, pellet grills have their container connected to the auger making it very difficult to change the wood used to flavor the meat, and therefore most people smoke with only one wood type, or mix the wood at the start of the smoke. This limitation limits the ability of the chef to create unique flavors In the smoke meats. This limitation is overcome using the present invention.

An additional improvement is found in the sliding door at the bottom of the container which can be closed by rotating the handle to reduce spilling out of the containers wood pellets when inserting or removing the container insert.

### DRAWINGS

### Brief Description of the Drawings

A better understanding of the present invention will be developed upon referencing of the accompanying drawings in which the numerals refer to like parts throughout the several views and wherein:

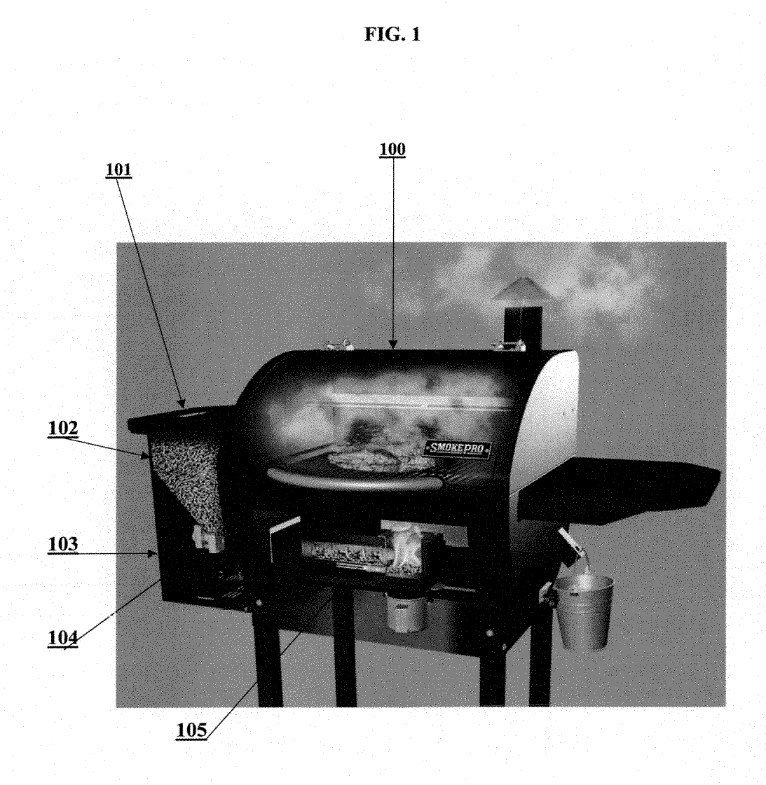

FIG. 1 is a pictorial representation of a barbecue grill smoker 100 and an attached, hot swappable grill smoker element container case apparatus 103 according to the present invention with a top lid 101, wood smoke element holder insert 102, which is connected to an auger 104, which feeds the wood element from the container into the internal heat box 105 of the grill, which smokes the meat in the smoker grill 100.

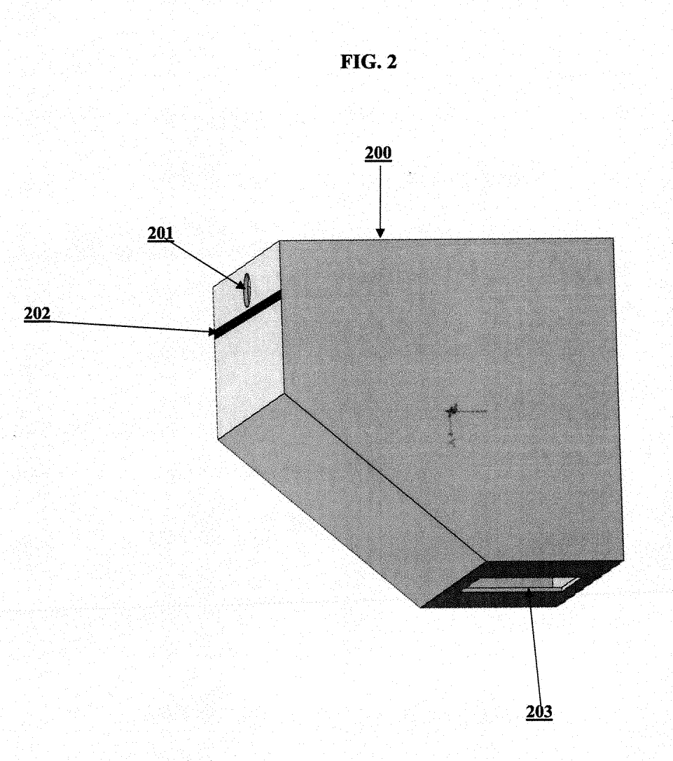

FIG. 2 is an angled view of the present invention, showing the wood elements holder insert 200, to see the back, side and bottom of the insert. This view illustrates the cut-out for the handle end 201, the insert connecting clamp 202 which clips the insert to the case 103, and the feeder hole cut-out 203 with the trap door open, which would allow wood elements to be fed into a connected auger.

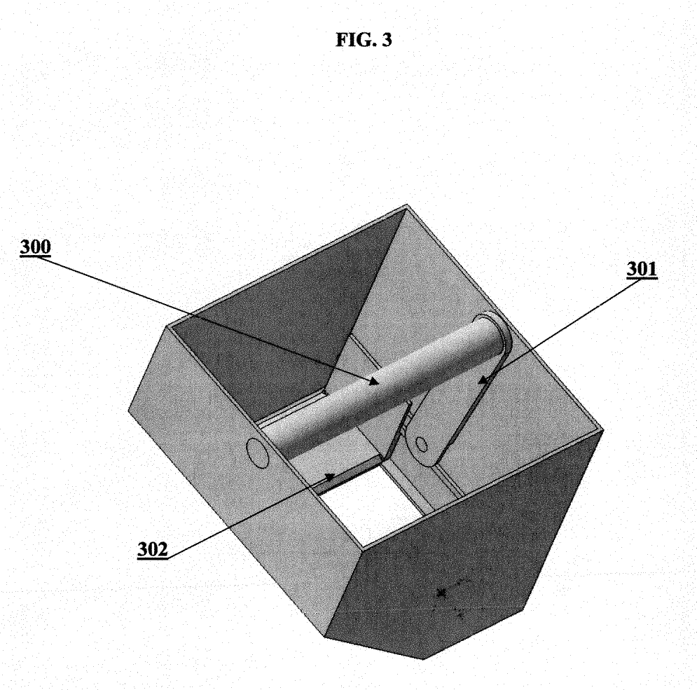

FIG. 3 is a top view of the container insert assembly to show the connection of handle 300, the arm mechanism 301, and the sliding trap door at the bottom of the container insert 302, where twisting the handle 300 opens and closes the trap of feeder door at the bottom of the container insert.

### DETAILED DESCRIPTION OF PREFERRED EMBODIMENT

Although the present invention can be made from many different materials or combination of materials, and in many different forms, one preferred embodiment is described in this disclosure and shown in the attached drawings. This disclosure exemplifies the principles of the present invention and does not limit the broad aspects of the invention only to the illustrated embodiment. The following description is not to be taken in a limiting sense, but is made merely for the purpose of illustrating the general principles of the invention, since the scope of the invention is best defined by the claims, which will be appended in the non-provisional filing.

FIG. 1 is a perspective view of the preferred embodiment of a grill smoker element container assembly, including the housing body 103, top lid 101, and element holder insert 102 made in accordance with the principals of the present invention connected to a grill smoker 100. This view illustrates the angled smoke element container 102 which facilitates the easy flow of wood elements down to the door at the bottom of the container assembly to feed an attached auger 104.

FIG. 2 is an angled view of the preferred embodiment of the container insert 200, to show the back, side and bottom. Cut-out hole 201 holds one end of the handle which is attached a the other end to a movable arm mechanism that is in combination opens and closes s door 203, at the bottom of the container assembly. Connector clips 202 connects to a clip on the assembly case body to hold the insert in place.

FIG. 3 is a top view of the preferred embodiment of the container insert showing the handle 300 which when turned rotates assembly arm 301 to open and close the sliding door at the bottom 302, which opens to feed the wood element into the auger that feeds the wood element into the smoke chamber of the grill.

In a preferred embodiment of the present invention the lid of the container assembly is lifted to reveal the container insert, and the handle which is used to pull the container insert which holds one type of wood element, which for this example is oak wood, and swap the container insert for another container insert holding a cherry wood element, each container being the same size and dimension and fitting into the container case perfectly.

In another preferred embodiment of the present invention the container holding one type of wood element is used for a specific amount of time during the smoking process, and is swapped for two or more containers each holding a different type of wood element with each being allowed to smoke the meat in the smoker for a certain amount of time to create unique flavors in the meat being smoked. Currently, pellet grills have their container connected to the auger making it very difficult to change the woods used to flavor the meat, and therefore most people smoke with only one wood type, or mix the woods at the start of the smoke. This limitation limits the ability of the chef to create unique flavors in the smoke meats by smoking with different types of woods, without opening the smoker lid, or greatly varying the temperature during the smoking process. These limitations are overcome using the present invention.

We claim:

1. A hot swappable grill smoker element container assembly comprising of:
a housing body with a clamp;
a top lid;
a angled smoke element holder insert with an attached handle;
a trap door assembly at the bottom of the element holder, connected to a sliding handle and a feed auger.

2. The grill smoker assembly of claim 1, wherein the housing body, top lid, and element holder insert are connected to a grill smoker with attached clips.

3. The grill smoker assembly of claim 1, wherein a preferred angle on the angled smoker element container facilitates the easy flow of wood elements down the trap door assembly at the bottom of the element holder to feed an attached auger.

4. The grill smoker assembly of claim 2, wherein a Cut-out hole holds one end of the handle which is attached at the other end to a movable arm mechanism that in combination opens and closes the trap door at the bottom of the container assembly to allow wood elements to flow to the auger.

5. The grill smoker assembly of claim 1, wherein multiple elements containers holding various types of wood elements are interchanged or hot swapped, mixing the smoke elements during the smoking process to create new and unique flavors in the meats, without lifting the lid of the grill or smoker, interrupting the cooking process or effecting the cooking temperatures.

6. The grill smoker assembly of claim 4, wherein the handle and the lever which allows the adding of the coals or wood elements quickly to keep temperatures inside the smoker between 225 and 250 degrees. The already lit elements inside the smoker will start the newly added elements gradually, maintaining the temperature.
